(19) United States
(12) Patent Application Publication
(10) Pub. No.: US 2026/0194444 A1
(43) Pub. Date: Jul. 9, 2026

(54) DATA AUGMENTATION METHOD AND DEVICE, STORAGE MEDIUM, AND COMPUTER PROGRAM PRODUCT

(71) Applicant: SHENZHEN UNIVERSITY, Shenzhen (CN)

(72) Inventors: Mingyang ZHANG, Shenzhen (CN); Weilun WANG, Shenzhen (CN)

(73) Assignee: SHENZHEN UNIVERSITY, Shenzhen (CN)

(21) Appl. No.: 19/440,499

(22) Filed: Jan. 5, 2026

(30) Foreign Application Priority Data
Jan. 7, 2025 (CN) 202510023450.0

(51) Int. Cl. G01N 17/00

(52) U.S. Cl. CPC G01N 17/006

(57) ABSTRACT

A data augmentation method includes: obtaining spatial distribution of reinforcing steel corrosion rate along a length direction, determining a standard deviation of the reinforcing steel corrosion rate based on the spatial distribution of reinforcing steel corrosion rate along the length direction, and determining a logarithmic functional relationship between the standard deviation of reinforcing steel corrosion rate and an average reinforcing steel corrosion rate through a fitting method; simulating the spatial distribution of reinforcing steel corrosion rate along the length direction using a Nataf transformation method to generate a distribution of reinforcing steel corrosion rate conforming to a logarithmic distribution, inputting the distribution of reinforcing steel corrosion rate into a finite element model of the reinforced concrete beam, and obtaining a crack width distribution corresponding to the distribution of reinforcing steel corrosion rate conforming to the logarithmic distribution; where the steps are repeatedly executed until a termination condition is met.

### CROSS-REFERENCE TO RELATED APPLICATIONS

This application claims priority to Chinese Patent Application No. 202510023450.0, filed on Jan. 7, 2025, the entire contents of which are incorporated herein by reference.

### TECHNICAL FIELD

The present application relates to the technical field of long-term performance degradation prediction for bridges, and in particular to a data augmentation method, a data augmentation device, a storage medium, and a computer program product.

### BACKGROUND

In chloride environments, reinforcing steel corrosion is a major cause of performance degradation in reinforced concrete structures. The passive film on the reinforcing steel is relatively stable in the highly alkaline environment of concrete. However, when the passive film on the reinforcing steel is damaged by chloride ion attack, the reinforcing steel corrodes. The volume expansion of the corrosion products leads to cracking and even spalling of the concrete cover. Aggressive media from the external environment may then more easily reach the reinforcing steel surface, accelerating the corrosion process. With a significant decrease in the cross-sectional area of the reinforcing steel and the bond strength between the concrete and the reinforcing steel, the load-bearing capacity is reduced, leading to service performance failure and long-term structural deterioration.

In structural detection methods, visual detection is a low-cost and widely used technique for assessing the deterioration of existing reinforced concrete structures, and it has been extensively used in developing maintenance strategies for existing bridges. For corroded reinforced concrete structures, the crack width of concrete surface caused by reinforcing steel corrosion is the most commonly used visual detection indicator. Many researchers have attempted to correlate the reinforcing steel corrosion state (i.e., cross-sectional area loss) with crack width, and have provided numerous empirical and mechanical models to describe the relationship between the reinforcing steel corrosion degree and crack width. Once the random variables involved in predicting reinforcing steel corrosion are identified and the relationship between reinforcing steel corrosion amount and crack width is established, updating theory and nonlinear filtering techniques can be applied to reduce the uncertainty in predicting structural performance deterioration.

Due to the combined influence of various factors, such as different environmental exposure conditions, concrete cover thickness, and construction quality, reinforcing steel corrosion exhibits a non-uniform spatial distribution. At the same time, the crack width caused by surface corrosion of the bridge structure surface also shows the characteristics of randomness and non-uniform distribution in space. The structural bearing capacity of reinforced concrete beam member strongly depends on the local conditions of the reinforcing steel. Ignoring the spatial variability of reinforcing steel corrosion will lead to an oversimplification of the prediction of the remaining service life of bridge structures. Therefore, establishing the relationship between the reinforcing steel corrosion rate distribution and the crack width distribution (i.e., a sequence-to-sequence mapping relationship) is crucial for the performance analysis and prediction of bridge structures. However, the data available for obtaining the sequence-to-sequence mapping relationship under existing laboratory conditions is very limited.

### SUMMARY

The main purpose of the present application is to provide a data augmentation method, a data augmentation device, a storage medium, and a computer program product, aiming to solve the problem of limited data available for obtaining the type of sequence-to-sequence mapping relationship under existing laboratory conditions.

In order to achieve the above purpose, the present application provides a data augmentation method, including:
obtaining spatial distribution of reinforcing steel corrosion rate along a length direction, determining a standard deviation of the reinforcing steel corrosion rate based on the spatial distribution of reinforcing steel corrosion rate along the length direction, and determining a logarithmic functional relationship between the standard deviation of reinforcing steel corrosion rate and an average reinforcing steel corrosion rate through a fitting method;
simulating the spatial distribution of reinforcing steel corrosion rate along the length direction using a Nataf transformation method based on the standard deviation of the reinforcing steel corrosion rate and the average reinforcing steel corrosion rate to generate a distribution of reinforcing steel corrosion rate conforming to a logarithmic distribution, inputting the distribution of reinforcing steel corrosion rate into a finite element model of the reinforced concrete beam, and obtaining a crack width distribution corresponding to the distribution of reinforcing steel corrosion rate conforming to the logarithmic distribution; and
repeatedly performing the steps of: obtaining the spatial distribution of reinforcing steel corrosion rate along the length direction, determining the standard deviation of the reinforcing steel corrosion rate based on the spatial distribution of the reinforcing steel corrosion rate along the length direction, and determining the logarithmic functional relationship between the standard deviation of the reinforcing steel corrosion rate and the average reinforcing steel corrosion rate through the fitting method, and simulating the spatial distribution of reinforcing steel corrosion rate along the length direction using the Nataf transformation method based on the standard deviation of the reinforcing steel corrosion rate and the average reinforcing steel corrosion rate to generate the distribution of reinforcing steel corrosion rate conforming to the logarithmic distribution, inputting the distribution of reinforcing steel corrosion rate into the finite element model of the reinforced concrete beam to obtain the crack width distribution corresponding to the distribution of reinforcing steel corrosion rate conforming to the logarithmic distribution, until a termination condition is met, ending the calculation and establishing a mapping relationship between the spatial distribution of the reinforcing steel corrosion rate and the crack width distribution.

In an embodiment, the logarithmic functional relationship between the standard deviation of the reinforcing steel corrosion rate and the average reinforcing steel corrosion rate is:

υ=0.08ηₐ^{0.5}
where υ is a standard deviation of the reinforcing steel corrosion rate, and ηₐ is an average reinforcing steel corrosion rate.

In an embodiment, the simulating the spatial distribution of reinforcing steel corrosion rate along the length direction using the Nataf transformation method based on the standard deviation of the reinforcing steel corrosion rate and the average reinforcing steel corrosion rate to generate the distribution of reinforcing steel corrosion rate conforming to the logarithmic distribution, inputting the distribution of reinforcing steel corrosion rate into the finite element model of the reinforced concrete beam, and obtaining the crack width distribution corresponding to the distribution of reinforcing steel corrosion rate conforming to the logarithmic distribution includes:
simulating the spatial distribution of reinforcing steel corrosion rate along the length direction using the Nataf transformation method based on the standard deviation of the reinforcing steel corrosion rate and the average reinforcing steel corrosion rate, and generating the distribution of reinforcing steel corrosion rate conforming to a logarithmic distribution;
inputting the distribution of reinforcing steel corrosion rate conforming to the logarithmic distribution into a reinforcing steel corrosion expansion model, and calculating an element node expansion displacement applied to a reinforced concrete interface; and
inputting the element node expansion displacement applied to the reinforced concrete interface into the finite element model of the reinforced concrete beam to simulate non-uniform corrosion around the reinforcing steel and along a reinforcing steel axis, and obtaining the crack width distribution corresponding to the distribution of reinforcing steel corrosion rate conforming to the logarithmic distribution.

In an embodiment, non-uniform corrosion around the reinforcing steel generates non-uniform radial expansion pressure on surrounding concrete, and using a corrosion distribution curve to express corrosion expansion behavior of each reinforcing steel cross-section, and the expression for the corrosion distribution curve is:

$${u}_{θ} = \{ \begin{matrix}{u}_{2} & 0 ° \leq θ \leq 180 ° \\ \frac{( R + {u}_{1} ) \cdot ( R + {u}_{2} )}{\sqrt{{( R + {u}_{1} )}^{2} {cos}^{2} θ + {( R + {u}_{2} )}^{2} {sin}^{2} θ}} - R & 180 ° < θ \leq 360 °\end{matrix}$$

where u_{θ} is a function value corresponding to the corrosion distribution curve, R is an original radius of the reinforcing steel, u₁ is a maximum corrosion layer thickness closest to a concrete surface, and u₂ is a corrosion layer thickness on a side away from the concrete surface.

In an embodiment, a relationship for the element node expansion displacement applied to the reinforced concrete interface is as follows:

$${u}_{1} = 10 ( 2 R {φ}^{- 1} η - 4 δ ) / 11$$

where u₁ is an element node expansion displacement applied to the reinforced concrete interface, and is a maximum corrosion layer thickness closest to the concrete surface; η is an experimentally measured corrosion rate, φ is a calibration coefficient, R is an original radius of the reinforcing steel, and δ is a thickness of the porous zone formed at the reinforcing steel or concrete interface.

In an embodiment, the establishing the finite element model of the reinforced concrete beam includes:
inputting a fracture softening curve into a concrete model to simulate tensile behavior of the concrete; and
establishing the finite element model of the reinforced concrete beam based on the tensile behavior of the concrete.

In an embodiment, the obtaining the spatial distribution of the reinforcing steel corrosion rate along the length direction includes:
obtaining design parameters of the reinforced concrete beam member, where the design parameters comprise a length, a cross-sectional dimension, a concrete strength, a concrete cover thickness, and a reinforcing steel diameter of the reinforced concrete beam member; and
based on the design parameters of the reinforced concrete beam, conducting an accelerated corrosion experiment on the reinforced concrete beam member by applying an electric current, and obtaining the spatial distribution of the reinforcing steel corrosion rate along the length direction.

In addition, in order to achieve the above purpose, the present application also provides a data augmentation device, including a memory, a processor, and a data augmentation program stored on the memory and executable on the processor, and the data augmentation program is configured to implement the data augmentation method as described above.

In addition, in order to achieve the above purpose, the present application also provides a computer-readable storage medium, a data augmentation program is stored on the storage medium, and the data augmentation computer program is configured to implement the data augmentation method as described above when executed by a processor.

In addition, in order to achieve the above purposes, the present application also provides a computer program product, including a data augmentation program, and the data augmentation computer program is configured to implement the data augmentation method as described above when executed by a processor.

The present application obtains spatial distribution of reinforcing steel corrosion rate along a length direction, determines a standard deviation of the reinforcing steel corrosion rate based on the spatial distribution of reinforcing steel corrosion rate along the length direction, and determines a logarithmic functional relationship between the standard deviation of reinforcing steel corrosion rate and an average reinforcing steel corrosion rate through a fitting method; simulates the spatial distribution of reinforcing steel corrosion rate along the length direction using a Nataf transformation method based on the standard deviation of the reinforcing steel corrosion rate and the average reinforcing steel corrosion rate to generate a distribution of reinforcing steel corrosion rate conforming to a logarithmic distribution, inputs the distribution of reinforcing steel corrosion rate into a finite element model of the reinforced concrete beam, and obtains a crack width distribution corresponding to the distribution of reinforcing steel corrosion rate conforming to the logarithmic distribution; and repeatedly performs the above steps until a termination condition is met, ends the calculation and establishes a mapping relationship between the spatial distribution of the reinforcing steel corrosion rate and the crack width distribution.

In this way, the present application may generate artificial data samples with the same characteristics as experimental samples, expanding the data on the relationship between the spatial distribution of reinforcing steel corrosion rate and the crack width distribution. By detecting the crack width distribution on the surface of reinforced concrete beam member, the spatial distribution of reinforcing steel corrosion rate inside the concrete structure may be predicted, enabling probabilistic prediction of the long-term performance of concrete structures. This provides a new data basis for establishing performance degradation evaluation of corroded concrete structures based on detection information, and also provides data support for the performance assessment of bridge member affected by corrosion in coastal environments. This has profound significance for the development of maintenance strategies for the entire life cycle of bridges under the influence of corrosion.

### BRIEF DESCRIPTION OF THE DRAWINGS

The accompanying drawings, which are incorporated in and constitute a part of this description, illustrate embodiments consistent with the present application and together with the description serve to explain the principles of the present application.

In order to more clearly illustrate the technical solutions in the embodiments of the present application or in the related art, drawings used in the embodiments or in the related art will be briefly described below. Obviously, the drawings in the following description are only some embodiments of the present application. It will be apparent to those skilled in the art that other figures can be obtained according to the structures shown in the drawings without creative work.

FIG. 1 is a flow chart of a data augmentation method according to an embodiment of the present application.

FIG. 2 is a flow chart of the data augmentation method according to another embodiment of the present application.

FIG. 3 is a flow chart of the data augmentation method according to another embodiment of the present application.

FIG. 4 is a flow chart of the data augmentation method according to another embodiment of the present application.

FIG. 5 is a schematic diagram of the data augmentation method according to an embodiment of the present application.

FIG. 6 is a schematic diagram of a front structure of a reinforced concrete beam member of the data augmentation method according to an embodiment of the present application.

FIG. 7 is a schematic diagram of a side structure of the reinforced concrete beam member of the data augmentation method according to an embodiment of the present application.

FIG. 8 is a schematic diagram of a finite element model of the reinforced concrete beam of the data augmentation method according to an embodiment of the present application.

FIG. 9 is a distribution diagram of reinforcing steel corrosion rate conforming to a logarithmic distribution of the data augmentation method according to an embodiment of the present application.

FIG. 10 is a schematic diagram of a reinforcing steel corrosion expansion model of the data augmentation method according to an embodiment of the present application.

FIG. 11 is a schematic diagram of a reinforcing steel corrosion expansion model of the data augmentation method according to another embodiment of the present application.

FIG. 12 is a scatter plot of data samples showing a mapping relationship between distribution of reinforcing steel corrosion rate and crack width distribution generated by the data augmentation method according to an embodiment of the present application.

FIG. 13 is a schematic diagram of a device structure of a hardware operating environment involved in the data augmentation method according to an embodiment of the present application.

The realization of the objectives, functional features and advantages of the present application will be further described with reference to the embodiments and the accompanying drawings.

### DETAILED DESCRIPTION OF THE EMBODIMENTS

It should be understood that the specific embodiments described herein are only used to explain the present application, and are not intended to limit the present application.

In order to better understand the technical solution of the present application, a detailed description will be given below in conjunction with the accompanying drawings and specific implementation methods.

In chloride environments, reinforcing steel corrosion is a major cause of performance degradation in reinforced concrete structures. The passive film on the reinforcing steel is relatively stable in the highly alkaline environment of concrete. However, when the passive film on the reinforcing steel is damaged by chloride ion attack, the reinforcing steel corrodes. The volume expansion of the corrosion products leads to cracking and even spalling of the concrete cover. Aggressive media from the external environment may then more easily reach the reinforcing steel surface, accelerating the corrosion process. With a significant decrease in the cross-sectional area of the reinforcing steel and the bond strength between the concrete and the reinforcing steel, the load-bearing capacity is reduced, leading to service performance failure and long-term structural deterioration.

In structural detection methods, visual detection is a low-cost and widely used technique for assessing the deterioration of existing reinforced concrete structures, and it has been extensively used in developing maintenance strategies for existing bridges. For corroded reinforced concrete structures, the crack width of concrete surface caused by reinforcing steel corrosion is the most commonly used visual detection indicator. Many researchers have attempted to correlate the reinforcing steel corrosion state (i.e., cross-sectional area loss) with crack width, and have provided numerous empirical and mechanical models to describe the relationship between the reinforcing steel corrosion degree and crack width. Once the random variables involved in predicting reinforcing steel corrosion are identified and the relationship between reinforcing steel corrosion amount and crack width is established, updating theory and nonlinear filtering techniques can be applied to reduce the uncertainty in predicting structural performance deterioration.

Due to the combined influence of various factors, such as different environmental exposure conditions, concrete cover thickness, and construction quality, reinforcing steel corrosion exhibits a non-uniform spatial distribution. At the same time, the crack width caused by surface corrosion of the bridge structure surface also shows the characteristics of randomness and non-uniform distribution in space. The structural bearing capacity of reinforced concrete beam member strongly depends on the local conditions of the reinforcing steel. Ignoring the spatial variability of reinforcing steel corrosion will lead to an oversimplification of the prediction of the remaining service life of bridge structures. Therefore, establishing the relationship between the reinforcing steel corrosion rate distribution and the crack width distribution (i.e., a sequence-to-sequence mapping relationship) is crucial for the performance analysis and prediction of bridge structures. However, the data available for obtaining the sequence-to-sequence mapping relationship under existing laboratory conditions is very limited.

In order to solve the above problems, the present application provides a data augmentation method.

It should be noted that the entity performing the data augmentation method described in the present application can be a computing service device with data processing, network communication, and program execution capabilities, such as a tablet computer, a personal computer, or a mobile phone, or any other electronic device capable of performing the above functions. The following takes a data augmentation device as an example to illustrate this embodiment and the following embodiments.

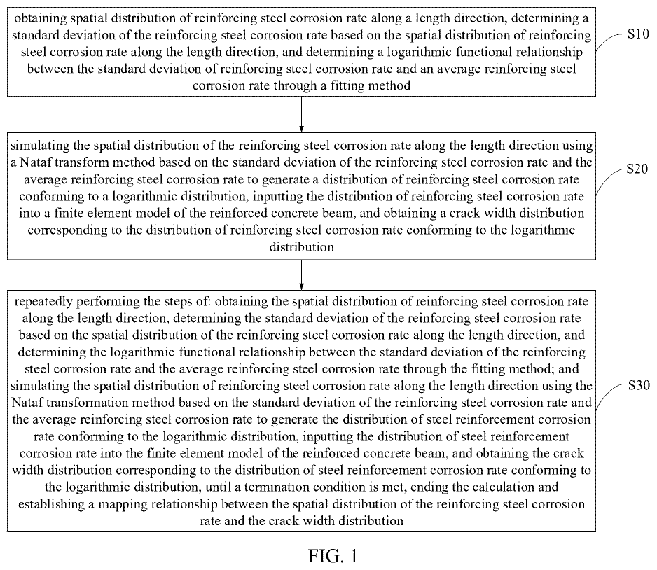

Based on this, the present application provides a data augmentation method. Referring to FIG. 1, the data augmentation method includes steps S10-S30.

S10, obtaining spatial distribution of reinforcing steel corrosion rate along a length direction, determining a standard deviation of the reinforcing steel corrosion rate based on the spatial distribution of reinforcing steel corrosion rate along the length direction, and determining a logarithmic functional relationship between the standard deviation of reinforcing steel corrosion rate and an average reinforcing steel corrosion rate through a fitting method.

In this embodiment, the design parameters of the reinforced concrete beam member are manually obtained, and may include, but are not limited to, parameters such as the length of the member, cross-sectional dimensions, concrete strength, cover thickness, reinforcing steel diameter, type of reinforcing steel, yield strength and tensile strength of the reinforcing steel, reinforcing steel ratio (number, diameter, and spacing of main reinforcing steel and stirrups), and the placement position of the reinforcing steel. In this way, based on similarity theory, the scale of the experimental model can be designed to ensure that the model reflects the mechanical behavior of the prototype during the experiment, and the experimental environmental conditions (such as temperature, humidity, and medium) are also set. Corrosion or durability experiments are then conducted on the reinforced concrete beam member. Data acquisition apparatus such as strain gauges, displacement sensors are provided at key locations on the reinforced concrete beam member to monitor parameters such as stress, strain, and deflection, and to obtain information on the appearance and development of cracks. This allows for obtaining, but not limited to, the distribution of reinforcing steel corrosion rate along a length direction, the crack width distribution on the concrete member surface, and the distribution of reinforcing steel corrosion locations corresponding to the crack width distribution on the surface of the concrete member. The distribution of the reinforcing steel corrosion rate along the length direction, the crack width distribution on the concrete member surface, and the reinforcing steel corrosion location distribution are then stored as sample data in a data augmentation device.

During data augmentation, the data augmentation device extracts the spatial distribution of reinforcing steel corrosion rate along the length direction from the sample data. Using the standard deviation formula and the mean formula, it calculates the standard deviation of the reinforcing steel corrosion rate and the average reinforcing steel corrosion rate. The standard deviation of the reinforcing steel corrosion rate is also known as the corrosion spatial variability characteristic parameter. Then, through a fitting method, the relationship between the standard deviation of the reinforcing steel corrosion rate and the average reinforcing steel corrosion rate is determined.

Based on the above, it should be noted that fitting methods are a group of statistical techniques used to determine the relationship between observed data and one or more theoretical models, and to use these models to predict or explain unknown data. Fitting methods are typically used to find the mathematical function or curve that best fits the observed data, and these functions or curves can then be used to predict or infer unknown data. Commonly used fitting methods include least squares method, nonlinear least squares method, polynomial fitting method, and local fitting methods, etc.

In an embodiment of the present application, the relationship between the standard deviation of the reinforcing steel corrosion rate and the average reinforcing steel corrosion rate is a logarithmic function, specifically as follows:

$$v = 0.08 {η}_{a}^{0.5}$$

Where υ is the standard deviation of the reinforcing steel corrosion rate, and ηₐ is the average reinforcing steel corrosion rate.

S20, simulating the spatial distribution of reinforcing steel corrosion rate along the length direction using a Nataf transformation method based on the standard deviation of the reinforcing steel corrosion rate and the average reinforcing steel corrosion rate to generate a distribution of reinforcing steel corrosion rate conforming to a logarithmic distribution, inputting the distribution of reinforcing steel corrosion rate into a finite element model of the reinforced concrete beam, and obtaining a crack width distribution corresponding to the distribution of reinforcing steel corrosion rate conforming to the logarithmic distribution.

In this embodiment, due to the significant uncertainty in the reinforcing steel corrosion along the length direction, a probabilistic method is required for simulation. The spatial variability of reinforcing steel corrosion (standard deviation of the reinforcing steel corrosion rate) is simulated using a logarithmic distribution. By combining the logarithmic distribution with the Nataf transformation method, the corrosion correlation between reinforcing steel elements may be considered in the simulation.

Specifically, the corrosion correlation between reinforcing steel elements can be characterized by the autocorrelation function, and the exponential correlation function is used to express ρ_{i,j}.

$${ρ}_{i , j} = exp ( - \frac{\vert τ \vert}{L} )$$

Where, ρ_{i,j} is a function value used to represent the corrosion correlation between reinforcing steel elements; L is a parameter representing the correlation length, which can be obtained based on the distribution of reinforcing steel corrosion rate along the length direction in the above embodiment. In this embodiment, L is 31.4 mm; τ=xᵢ−xⱼ is the center-to-center spacing between two adjacent reinforcing steel elements along the length direction of the reinforcing steel.

It should be noted that the Nataf transformation can be used to transform any random variable into a standard Gaussian distribution. The marginal cumulative density function of the n-dimensional correlated random vector X=[X₁, X₂, . . . , Xₙ] is F_{X}_{ᵢ}(xᵢ), and the correlation coefficient matrix is ρ=[ρ_{i,j}]. Through the Nataf transformation, X can be transformed into independent standard normal variables Y=[Yᵢ]. The process of the Nataf transformation is as follows: the correlated standard normal variables Y=[Yᵢ] can be transformed from X using the following formula:

$${y}_{j} = {Φ}^{- 1} ( {F}_{{X}_{i}} ( {x}_{i} ) )$$

Where yⱼ is an array element of [Yᵢ], F_{X}_{ᵢ}(xᵢ) is the marginal cumulative distribution function, and Φ⁻¹(⋅) is the inverse marginal cumulative distribution function of the standard Gaussian distribution. The correlation coefficient matrix of Y is ρ₀=[ρ_{0i,j}]. The relationship between ρ_{i,j} and ρ_{0i,j} is shown in the following equation:

$${ρ}_{i , j} = {\int }_{- ∞}^{∞} {\int }_{- ∞}^{∞} \frac{{F}_{i}^{- 1} ( Φ ( {y}_{i} ) ) - {m}_{{x}_{i}}}{{s}_{{x}_{i}}} \cdot \frac{{F}_{j}^{- 1} ( Φ ( {y}_{j} ) ) - {m}_{{x}_{j}}}{{s}_{{x}_{j}}} {ϕ}_{2} ( {y}_{i} , {y}_{j} ; {ρ}_{0 i , j} ) {dy}_{i} {dy}_{j}$$

Where φ₂(yᵢ,yⱼ;ρ_{0i,j}) is given by the equation

$${ϕ}_{2} ( {y}_{i} , {y}_{j} ; {ρ}_{0 i , j} ) = \frac{1}{\sqrt{{( 2 π )}^{n} det ( {ρ}_{0} )}} exp ( - \frac{1}{2} {y}^{T} {ρ}_{0}^{- 1} y ) ,$$

mₓ_{ᵢ} and mₓ_{ⱼ} are the means of the related variables xᵢ and xⱼ, respectively; and sₓ_{ᵢ} and sₓ_{ⱼ} are the standard deviations of the related variables xᵢ and xⱼ, respectively.

Where ρ_{0i,j} can be calculated from ρ_{i,j}, and the relationship between the two can be simplified using the following formula:

$${ρ}_{0 i , j} = {P}_{j , k} \cdot {ρ}_{i , j}$$

P_{i,j} can be estimated using a polynomial approximation as follows:

$${P}_{i , j} = \frac{{ρ}_{0 i , j}}{{ρ}_{i , j}} = {p}_{1} {ρ}_{i , j}^{3} + {p}_{2} {ρ}_{i , j}^{2} + {p}_{3} {ρ}_{i , j} + {p}_{4}$$

Where parameters p₁ to p₄ can be calculated using the Monte Carlo method. The obtained matrix ρ_{0i,j} allows ρ₀ to be decomposed into a lower triangular matrix and an upper triangular matrix through Cholesky decomposition, as shown in the following equation:

$${ρ}_{0} = A \cdot {A}^{T}$$

Where A=[a_{i,j}] is a lower triangular matrix. Therefore, the variable Y can be expressed as the product of A and independent standard normal variables U, as shown in the following equation:

$$Y = A \cdot U$$

The relationship between the independent standard normal variable U and the original correlated variable X can be established by the following equation:

$${X}_{1} = {F}_{{X}_{1}}^{- 1} ( Φ ( {a}_{11} {U}_{1} ) )$$

$${X}_{2} = {F}_{{X}_{2}}^{- 1} ( Φ ( {a}_{21} {U}_{1} + {a}_{22} {U}_{2} ) )$$

$$⋮$$

$${X}_{n} = {F}_{{X}_{n}}^{- 1} ( Φ ( {a}_{n 1} {U}_{1} + {a}_{n 2} {U}_{2} + ⋯ + {a}_{nn} {U}_{n} ) ) ;$$

After generating a distribution of reinforcing steel corrosion rate conforming to a logarithmic distribution, the data augmentation device inputs the distribution of reinforcing steel corrosion rate into a finite element model of the reinforced concrete beam. The finite element model of the reinforced concrete beam is then used to simulate the surface concrete cracking process caused by the corrosion expansion of the concrete surface, thereby obtaining a crack width distribution corresponding to the reinforcing steel corrosion rate conforming to a logarithmic distribution.

S30, repeatedly performing the steps of: obtaining the spatial distribution of reinforcing steel corrosion rate along the length direction, determining the standard deviation of the reinforcing steel corrosion rate based on the spatial distribution of the reinforcing steel corrosion rate along the length direction, and determining the logarithmic functional relationship between the standard deviation of the reinforcing steel corrosion rate and the average reinforcing steel corrosion rate through the fitting method; and simulating the spatial distribution of reinforcing steel corrosion rate along the length direction using the Nataf transformation method based on the standard deviation of the reinforcing steel corrosion rate and the average reinforcing steel corrosion rate to generate the distribution of reinforcing steel corrosion rate conforming to the logarithmic distribution, inputting the distribution of reinforcing steel corrosion rate into the finite element model of the reinforced concrete beam, and obtaining the crack width distribution corresponding to the distribution of reinforcing steel corrosion rate conforming to the logarithmic distribution, until a termination condition is met, ending the calculation and establishing a mapping relationship between the spatial distribution of the reinforcing steel corrosion rate and the crack width distribution.

In this embodiment, steps S10 to S20 are executed repeatedly, spatial distributions of reinforcing steel corrosion rate under different corrosion degrees are generated through a plurality of samplings, and a one-to-one correspondence is established with the crack width distribution on the concrete surface generated under each spatial distribution of reinforcing steel corrosion rate. This process continues until both the quantities of spatial distributions of reinforcing steel corrosion rate and crack width distributions reach the target sample size, indicating that quantities meets the conditions for establishing a mapping relationship between the spatial distribution of reinforcing steel corrosion rate and the crack width distribution. The calculation then returns to establish the mapping relationship between the spatial distribution of reinforcing steel corrosion rate and the crack width distribution, generating artificial data samples with the same characteristics as the experimental samples, thus expanding the data on the relationship between spatial distribution of reinforcing steel corrosion rate and crack width distribution.

The present application obtains spatial distribution of reinforcing steel corrosion rate along a length direction, determines a standard deviation of the reinforcing steel corrosion rate based on the spatial distribution of reinforcing steel corrosion rate along the length direction, and determines a logarithmic functional relationship between the standard deviation of reinforcing steel corrosion rate and an average reinforcing steel corrosion rate through a fitting method; simulates the spatial distribution of reinforcing steel corrosion rate along the length direction using a Nataf transformation method based on the standard deviation of the reinforcing steel corrosion rate and the average reinforcing steel corrosion rate to generate a distribution of reinforcing steel corrosion rate conforming to a logarithmic distribution, inputs the distribution of reinforcing steel corrosion rate into a finite element model of the reinforced concrete beam, and obtains a crack width distribution corresponding to the distribution of reinforcing steel corrosion rate conforming to the logarithmic distribution; and repeatedly performs the above steps until a termination condition is met, ends the calculation and establishes a mapping relationship between the spatial distribution of the reinforcing steel corrosion rate and the crack width distribution. In this way, the present application may generate artificial data samples with the same characteristics as experimental samples, expanding the data on the relationship between the spatial distribution of reinforcing steel corrosion rate and the crack width distribution. By detecting the crack width distribution on the surface of reinforced concrete beam member, the spatial distribution of reinforcing steel corrosion rate inside the concrete structure may be predicted, enabling probabilistic prediction of the long-term performance of concrete structures. This provides a new data basis for establishing performance degradation evaluation of corroded concrete structures based on detection information, and also provides data support for the performance assessment of bridge member affected by corrosion in coastal environments. This has profound significance for the development of maintenance strategies for the entire life cycle of bridges under the influence of corrosion.

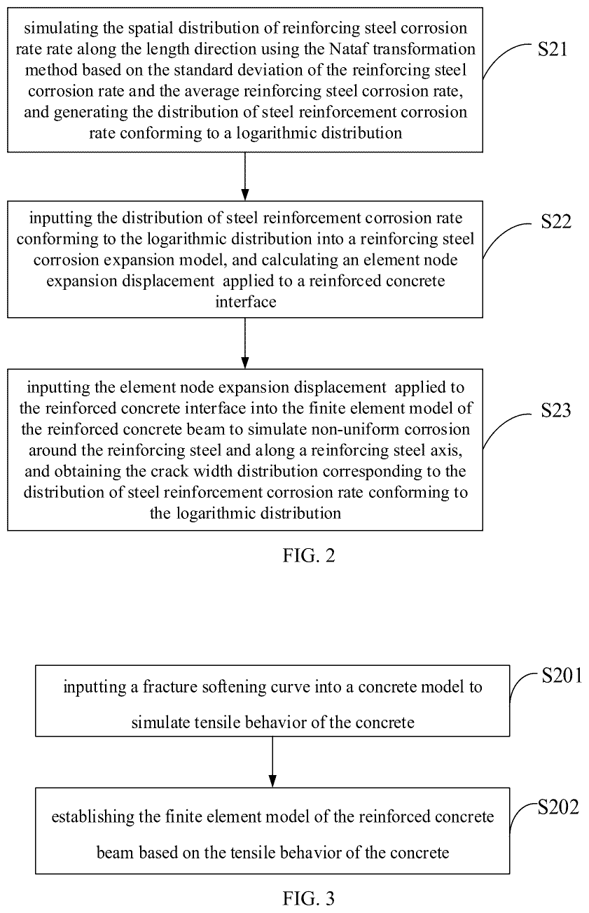

In an embodiment of the present application, referring to FIG. 2, the S20 includes steps S21-S23.

S21, simulating the spatial distribution of reinforcing steel corrosion rate along the length direction using the Nataf transformation method based on the standard deviation of the reinforcing steel corrosion rate and the average reinforcing steel corrosion rate, and generating a distribution of reinforcing steel corrosion rate conforming to a logarithmic distribution.

It should be noted that the process of generating the distribution of reinforcing steel corrosion rate conforming to a logarithmic distribution has already been described above. Referring to the content above for details; this embodiment and the following embodiment will not repeat this description.

S22, inputting the distribution of reinforcing steel corrosion rate conforming to the logarithmic distribution into a reinforcing steel corrosion expansion model, and calculating an element node expansion displacement applied to a reinforced concrete interface.

S23, inputting the element node expansion displacement applied to the reinforced concrete interface into the finite element model of the reinforced concrete beam to simulate non-uniform corrosion around the reinforcing steel and along a reinforcing steel axis, and obtaining the crack width distribution corresponding to the distribution of reinforcing steel corrosion rate conforming to the logarithmic distribution.

It should be noted that both the reinforcing steel corrosion expansion model and the finite element model of the reinforced concrete beam are pre-stored in the data augmentation device. The reinforcing steel corrosion expansion model is used to simulate the corrosion expansion of the concrete surface, and the finite element model of the reinforced concrete beam is used to simulate the cracking process of the concrete surface caused by corrosion. The synergistic effect of the two models is primarily used for finite element simulation of the cracking process of the concrete surface caused by corrosion expansion.

In order to reduce the complexity of establishing the reinforcing steel corrosion expansion model and the finite element model of the reinforced concrete beam, some parameters that have little impact on obtaining the mapping relationship between the spatial distribution of reinforcing steel corrosion rate and the crack width distribution can be ignored, assumed, or simulated using similar methods. For example, since the compressive behavior of concrete has little effect on the calculation results of corrosion crack width, the compressive behavior of concrete can be assumed to be that of an ideal elastic material. The reinforcing steel corrosion expansion model can be considered as an element node expansion displacement applied to the reinforced concrete interface, i.e., a radial displacement applied to the reinforced concrete interface. When establishing the finite element model of the reinforced concrete beam, the reinforcing steel can be simulated as a “hole”, and the non-uniform corrosion around and along the reinforcing steel axis can be simulated by applying radial displacement to represent the spatial expansion of reinforcing steel corrosion. For example, several assumptions can be made in the corrosion expansion process simulation, including: First, the rust can be considered rigid, and its deformation can be ignored. Second, the influence of reinforcing steel corrosion of longitudinal reinforcing steel on the crack width caused by corrosion near adjacent longitudinal reinforcing steel is not considered; only the relationship between the spatial distribution of reinforcing steel corrosion rate of longitudinal reinforcing steel and the crack width caused by corrosion is considered. Third, the influence of stirrups on the crack width is ignored in the finite element model. In this way, the complexity of establishing the reinforcing steel corrosion expansion model and the finite element model of the reinforced concrete beam can be simplified without affecting the subsequent analysis of the mapping relationship between the spatial distribution of reinforcing steel corrosion rate and the crack width distribution based on the reinforcing steel corrosion expansion model and the finite element model of the reinforced concrete beam.

In an embodiment of the present application, referring to FIG. 3, the steps for establishing the finite element model of the reinforced concrete beam specifically include steps S201-S202.

S201, inputting a fracture softening curve into a concrete model to simulate tensile behavior of the concrete.

S202, establishing the finite element model of the reinforced concrete beam based on the tensile behavior of the concrete.

In this embodiment, the concrete structure can be divided into a plurality of three-dimensional eight-node solid elements. Each element has eight vertices, which can more accurately capture complex geometric shapes and stress distributions. Concrete exhibits nonlinear behavior during tension, particularly brittle fracture after reaching the ultimate limit state. This embodiment uses a linear softening curve to describe the process of concrete from the initial appearance of microcracks to complete fracture, that is, the phenomenon of the stress-strain relationship of concrete gradually softening (i.e., stress decreasing while strain continues to increase). Fracture energy (G_{f}) is introduced to measure the material's ability to absorb energy before fracture, thus quantifying this softening behavior. Furthermore, a crack bandwidth parameter h is introduced to characterize the width of crack propagation in the concrete. The crack bandwidth h is defined as the cube root of the mesh element volume, aiming to ensure that the crack width matches the discretization of the model and improves the rationality of the simulation.

It should be noted that the CEB-FIP (Joint Committee of the International Federation for Structural Concrete and the European Committee for Concrete) model code is one of the international standards for concrete structure design and analysis. The 2010 edition of the model code provides a method for calculating the fracture energy of concrete. This implementation uses the 2010 model to accurately assess the energy absorption capacity of concrete during the fracture process. It can be assumed that concrete behaves as an ideal elastic material under compression, neglecting the plastic deformation or damage that may occur in real concrete under high pressure. This simplifies the data analysis of the model, allowing for a focus on the tensile and corrosion problems of the concrete.

In this embodiment, the volume expansion caused by reinforcing steel corrosion is simulated by applying displacement at the reinforced concrete interface. This accounts for the non-uniform expansion behavior caused by corrosion and simultaneously simulates the spatial variation of this corrosion phenomenon along the reinforcing steel axis. During the establishment of the finite element model, the reinforcing steel is not directly modeled as a solid body; instead, a “hole” is created at its location (i.e., the space occupied by the reinforcing steel is removed), and the expansion effect of the reinforcing steel is simulated by applying radial displacement to the concrete elements surrounding this hole. This simplifies the modeling of the interaction between the reinforcing steel and the concrete while effectively capturing the complex stress state caused by reinforcing steel corrosion. Thus, this embodiment provides a numerical simulation method for establishing a finite element model of the reinforced concrete beam, aiming to comprehensively analyze the mechanical response of reinforced concrete structure under the action of reinforcing steel corrosion, including crack formation, propagation, and the interaction between concrete and reinforcing steel. This provides an important data basis for determining the mapping relationship between the spatial distribution of reinforcing steel corrosion rate and the crack width distribution.

In this embodiment, the data augmentation device inputs the distribution of reinforcing steel corrosion rate conforming to a logarithmic distribution steel into the reinforcing corrosion expansion model. The element node expansion displacement at the reinforced concrete interface can be obtained through the reinforcing steel corrosion expansion model. The element node expansion displacement at the reinforced concrete interface is then input into the finite element model of the reinforced concrete beam. The finite element model of the reinforced concrete beam simulates non-uniform corrosion around and along the axial direction of the reinforcing steel, obtaining a crack width distribution corresponding to the distribution of reinforcing steel corrosion rate conforming to a logarithmic distribution.

In an embodiment of the present application, since the non-uniform corrosion around the reinforcing steel generates non-uniform radial expansion pressure on the surrounding concrete, a corrosion distribution curve expressed in the form of an ellipse can be used to describe the corrosion expansion behavior of each reinforcing steel cross-section. As a continuous function, the elliptical expression may accurately describe the non-uniformity of corrosion expansion in the reinforcing steel cross-section, reflecting the distribution characteristics of corrosion on the reinforcing steel cross-section, such as the coexistence of severe local corrosion and slight corrosion, and simulating the differential impact of local corrosion on the structure.

In an embodiment of the present application, the expression for the corrosion distribution curve is:

$${u}_{θ} = \{ \begin{matrix}{u}_{2} & 0 ° \leq θ \leq 180 ° \\ \frac{( R + {u}_{1} ) \cdot ( R + {u}_{2} )}{\sqrt{{( R + {u}_{1} )}^{2} {cos}^{2} θ + {( R + {u}_{2} )}^{2} {sin}^{2} θ}} - R & 180 ° \leq θ \leq 360 °\end{matrix}$$

Where u_{θ} is the function value corresponding to the corrosion distribution curve, R is the original radius of the reinforcing steel, u₁ is the maximum corrosion layer thickness closest to the concrete surface, and u₂ is the corrosion layer thickness on the side away from the concrete surface.

It should be noted that the shape of the ellipse is determined by u₂/u₁, and here it is assumed that u₂/u₁=1/30.

In an embodiment of the present application, after the reinforcing steel begins to corrode, the rust can expand freely. Once the gaps in the porous zone between the reinforcing steel and the surrounding concrete are completely filled with rust, the expansion of the rust will exert pressure on the surrounding concrete, thereby generating tensile stress and leading to concrete cracking. Not all rust will lead to increased stress and initial cracking of the cover concrete; some rust may penetrate into the porous zone. The present application assumes that the porous zone is uniform, and a thickness δ is 12.5 μm. During the free expansion stage of the corrosion products, the volume of rust per unit length l can be expressed as:

$${V}_{rust 1} = {V}_{poro} + {V}_{steel 1}$$

Where Vₚₒᵣₒ is the volume of corrosion products that penetrate the porous zone at the steel/concrete interface (i.e., 2πRδl), and Vₛₜₑₑₗ₁ is the volume of corroded reinforcing steel during the free expansion stage of the corrosion products. Once the gaps in the porous zone are completely filled with rust, tensile stress will be generated in the surrounding concrete. After the gaps are filled with rust, the volume Vᵣᵤₛₜ₂ of rust per unit length l is:

$${V}_{rust 2} = {V}_{exp} + {V}_{steel 2}$$

$${V}_{exp} = π Rl ( {u}_{1} + 3 {u}_{2} ) / 2$$

Where Vₑₓₚ is the expansion volume per unit length l, Vₛₜₑₑₗ₂ is the volume of the reinforcing steel corroded after the gaps are filled with rust, u₁ is the maximum corrosion layer thickness closest to the concrete surface, u₂ is the corrosion layer thickness on the side away from the concrete surface, and R is the original radius of the reinforcing steel.

The total amount of corrosion Vᵣᵤₛₜ=Vᵣᵤₛₜ₁+Vᵣᵤₛₜ₂ is derived from three interrelated processes, each directly or indirectly related to reinforcing steel corrosion. Specifically, firstly, the total amount of corrosion includes the corrosion associated with the consumed reinforcing steel. Corrosion occurs directly on the reinforcing steel surface, and the volume of the corrosion products (mainly iron oxide) is greater than the original volume of the reinforcing steel, leading to expansion of the reinforcing steel's physical volume. Secondly, the total amount of corrosion includes the corrosion associated with penetration into the porous zone at the reinforcing steel/concrete interface. The iron oxide produced during the corrosion process can penetrate into the tiny gaps or pores between the reinforcing steel and the concrete. This penetration further exacerbates the bond failure between the reinforcing steel and the concrete and may also form corrosion channels, promoting the intrusion of more water and corrosive media, thus accelerating the corrosion process. Thirdly, the total amount of corrosion includes the corrosion associated with the expansive pressure exerted on the surrounding concrete. The volume expansion of the corrosion products exerts pressure on the surrounding concrete, leading to cracking or spalling of the concrete, reducing the structural integrity and durability. Since all rust is produced by reinforcing steel corrosion, the relationship is as follows:

$${V}_{rust} = β {V}_{steel}$$

Where Vᵣᵤₛₜ is total amount of corrosion, Vₛₜₑₑₗ is the total volume of the corroded reinforcing steel, and β is the volume expansion ratio of the corrosion products, which can be assumed to be 2.0.

Some rust may flow out of the structure through cracks caused by corrosion and penetrate into the surrounding concrete. The amount of rust penetrating into the surrounding concrete depends on different experimental conditions. For example, when conducting experiments with accelerated corrosion through electrification, the amount of rust penetrating into the surrounding concrete depends on the current density level during the experiment. Lower current densities provide more opportunities for rust to fill the pores in the surrounding concrete. Conversely, at higher current densities, some rust is less likely to induce cracking in the surrounding concrete. Therefore, the corrosion rate η′ in the expansion simulation is not the same as the experimentally measured corrosion rate η. In order to simplify this problem, a calibration coefficient φ can be introduced to account for the influence of impact current density and average reinforcing steel corrosion rate on the pressure causing corrosion cracks. The relationship between η and η′ can be expressed as:

$${η}^{′} = {φ}^{- 1} η$$

$$φ = {ξ}_{1} + {ξ}_{2} {η}_{a} + {ξ}_{3} {I}_{corr}^{{ξ}_{4}}$$

Where η′ is the corrosion rate in the expansion simulation, η is the experimentally measured corrosion rate, φ is the calibration coefficient, I_{corr} is the impact current density, and ηₐ is the average reinforcing steel corrosion rate. ξ₁ can be 0.903, ξ₂ can be 10.3, ξ₃ can be 24.2, and ξ₄ can be −0.663.

In an embodiment of the present application, u₁ is the maximum corrosion layer thickness closest to the concrete surface, and u₁ can be input as the finite element model of the reinforced concrete beam into the element node expansion displacement applied to the reinforced concrete interface. Where u₁ is determined by η, and the relationship is as follows:

$${u}_{1} = 10 ( 2 R {φ}^{- 1} η - 4 δ ) / 11$$

Where η is the experimentally measured corrosion rate, φ is the calibration coefficient, and R is the original radius of the reinforcing steel; and δ is the thickness of the porous zone, which can be specifically taken as 12.5 μm.

In this way, this embodiment may simulate and calculate the total amount of corrosion based on the finite element model of the reinforced concrete beam, and can take into account the corrosive effects of rust on both the reinforcing steel and the concrete, as well as the influence of impact current density and average reinforcing steel corrosion rate on the stress causing corrosion cracks under different experimental conditions. The simulated corrosion rate is corrected using calibration coefficients to improve the accuracy of finite element simulation, so as to better quantify the mapping relationship between the spatial distribution of reinforcing steel corrosion rate and crack width distribution.

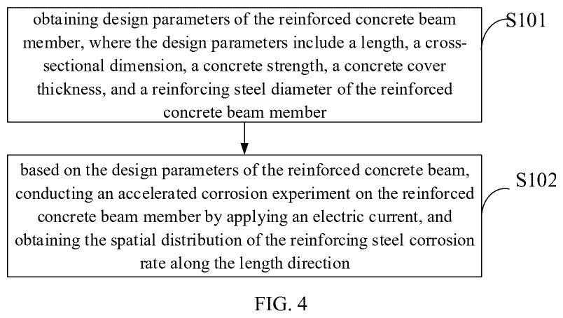

In an embodiment of the present application, referring to FIG. 4, the steps for establishing the spatial distribution of the reinforcing steel corrosion rate along the length direction include steps S101 to S102.

S101, obtaining design parameters of the reinforced concrete beam member, where the design parameters include a length, a cross-sectional dimension, a concrete strength, a concrete cover thickness, and a reinforcing steel diameter of the reinforced concrete beam member.

In this embodiment, regarding length and cross-sectional dimensions, for longer beams, due to the larger bending moment at mid-span, initial cracks are more likely to form in the tension zone. Once the reinforcing steel begins to corrode, the crack width may rapidly increase due to the reduction in the effective cross-sectional area of the reinforcing steel. For beams with larger cross-sectional dimensions, due to the larger moment of inertia, cracking is relatively less likely to occur, but if corrosion does occur, the internal corrosion is difficult to detect, and repair is more difficult. Regarding concrete strength, high-strength concrete provides better crack resistance, slowing down the formation of initial cracks. However, the reinforcing steel in high-strength concrete is more susceptible to alkali-aggregate reaction or chloride ion attack. These factors accelerate reinforcing steel corrosion, and the reduction in the cross-sectional area of the reinforcing steel due to corrosion increases stress concentration, thus exacerbating the propagation of existing cracks. Regarding the cover thickness, the cover thickness directly affects the degree of contact between the reinforcing steel and the external corrosive medium. For example, a thinner cover makes the reinforcing steel more susceptible to corrosive media, accelerating the corrosion process and potentially forming severe corrosion pits in localized areas, leading to a reduction in the cross-sectional area of the reinforcing steel in that area, promoting the formation and rapid propagation of cracks in these areas. Conversely, a thicker cover can effectively delay the corrosion process and reduce the occurrence and propagation of cracks. Regarding reinforcing steel diameter, although larger diameter reinforcing steel can provide stronger load-bearing capacity, corrosion on its surface is more likely to form noticeable corrosion pits, thus generating greater local pressure on the surrounding concrete, promoting the formation and propagation of cracks. Conversely, smaller diameter reinforcing steel results in a more uniform loss of cross-sectional area, which may have a relatively smaller impact on the crack width distribution, but it increases the density of the reinforcing steel, affecting the quality of concrete pouring.

Therefore, the length, cross-sectional dimensions, concrete strength, concrete cover thickness, and reinforcing steel diameter of reinforced concrete beam members are crucial in data augmentation for establishing the mapping relationship between the spatial distribution of reinforcing steel corrosion rate and crack width distribution, and should all be considered in experimental analysis.

S102, based on the design parameters of the reinforced concrete beam, conducting an accelerated corrosion experiment on the reinforced concrete beam member by applying an electric current, and obtaining the spatial distribution of the reinforcing steel corrosion rate along the length direction.

In this embodiment, the accelerated corrosion experiment under electrical current can simulate the corrosion process in a natural environment by applying direct current to the reinforcing steel in reinforced concrete beam members, thereby accelerating the reinforcing steel corrosion rate. Specifically, the positive electrode of the direct current power supply is connected to the reinforcing steel, and the negative electrode is connected to the electrolyte (such as simulated seawater or sodium sulfate solution), forming an electrolytic cell that accelerates the dissolution process of the reinforcing steel. Electrochemical techniques such as electrochemical impedance spectroscopy (EIS) and linear polarization resistance (LPR) can be used to periodically measure the corrosion current density of the reinforcing steel. Combined with the weight loss method, the average corrosion rate and the distribution of the reinforcing steel can be calculated. The non-uniformity of the corrosion rate leads to significantly higher corrosion rates in some areas of the reinforcing steel compared to others. X-ray technology, digital image processing technology, or ultrasonic testing can be used to monitor the formation and propagation of cracks on the surface and inside of the reinforced concrete. Particular attention can be paid to the crack dynamics close to the reinforcing steel corrosion areas, as the concrete in these areas is subjected to additional stress due to the expansion of the reinforcing steel and is prone to cracking. As corrosion progresses, the crack width around the reinforcing steel corrosion areas shows a non-uniform distribution, corresponding to the distribution of the reinforcing steel corrosion rate. Crack widths are larger near corrosion hotspots (areas with high corrosion rates).

In summary, the present application, by conducting accelerated corrosion experiments on reinforced concrete beam members using electrical current, can obtain, but is not limited to, the spatial distribution of the reinforcing steel corrosion rate along the length direction, as well as the crack width distribution on the concrete member surface, and the distribution of reinforcing steel corrosion locations corresponding to the crack width distribution on the concrete member surface. This provides experimental data to support subsequent statistical analysis and finite element analysis simulations, enabling the enhancement of the mapping relationship between the spatial distribution of reinforcing steel corrosion rate and the crack width.

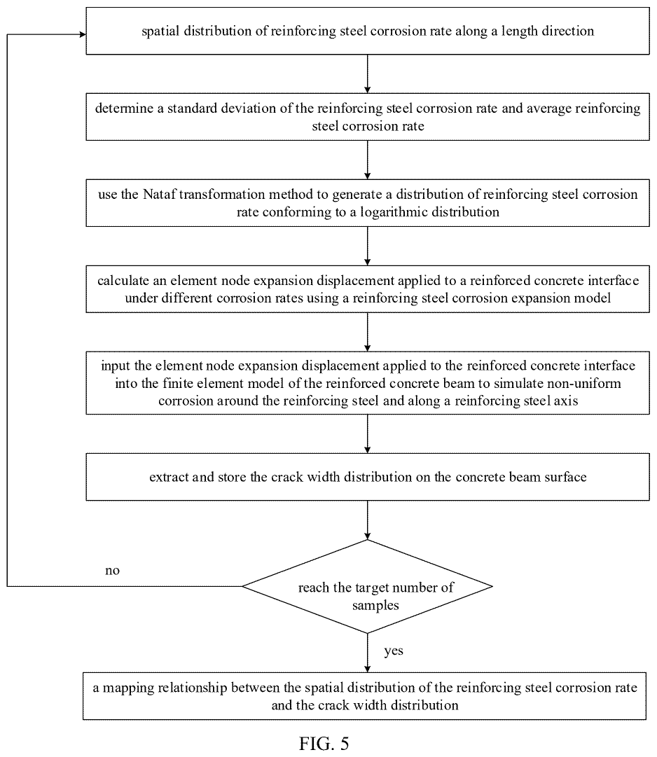

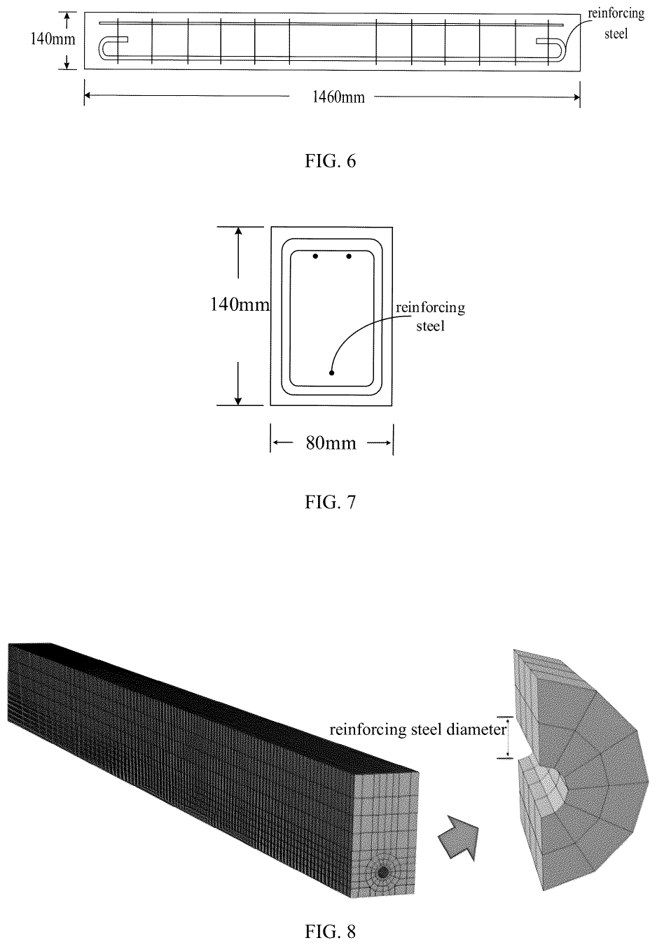

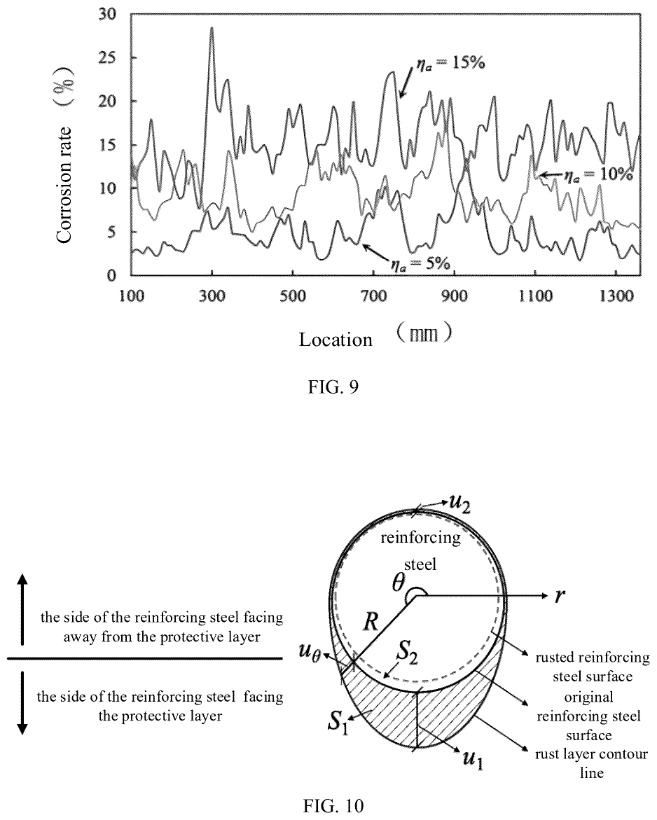

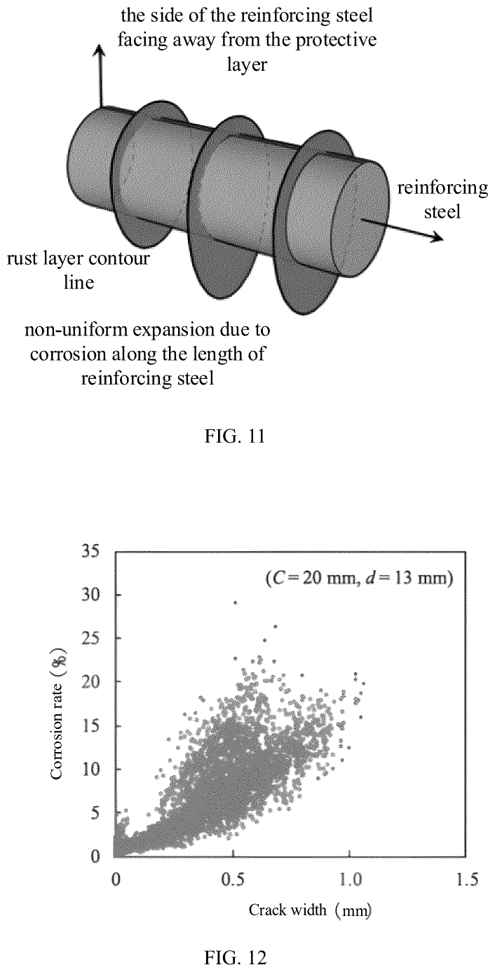

In an embodiment, referring to FIG. 5 to FIG. 12, the reinforced concrete beam member shown in FIG. 6 and FIG. 7 includes a longitudinal reinforcing steel. The beam has a cross-section of 80×140 mm², and a length of 1460 mm. Through accelerated corrosion experiments using electrical current, the spatial distribution of reinforcing steel corrosion rates at different corrosion levels and the crack width distribution on the reinforced concrete beam member surface can be obtained. Different experimental parameters can be used, such as reinforcing steel diameters of 13 mm or 19 mm, cover thicknesses of 10 mm or 20 mm, and the current densities can be 10 μA/cm², 50 μA/cm², 100 μA/cm², 200 μA/cm², 500 μA/cm², or 1000 μA/cm². Furthermore, based on the spatial distribution of the reinforcing steel corrosion rate along the length direction under experimental conditions, the standard deviation of the reinforcing steel and the average reinforcing steel corrosion rate can be calculated using the standard deviation formula and average difference formula. A logarithmic function relationship between the standard deviation of the reinforcing steel and the average reinforcing steel corrosion rate can be determined through a fitting method. Based on the standard deviation of the reinforcing steel and the average reinforcing steel corrosion rate, the Nataf transformation method can be introduced to simulate the spatial distribution of the reinforcing steel corrosion rate along the length direction, generating a distribution of reinforcing steel corrosion rate conforming to a logarithmic distribution, Referring to FIG. 9, FIG. 9 shows the distribution of reinforcing steel corrosion rate along the length of the reinforcing steel when the average reinforcing steel corrosion rate is 5%, 10%, and 15%, respectively. This distribution is then input into the reinforcing steel corrosion expansion model shown in FIG. 10 and FIG. 11 to calculate the element node expansion displacement applied to the reinforced concrete interface, simulating the corrosion expansion of the reinforcing steel The element node expansion displacement applied to the reinforced concrete interface can be input into the finite element model of the reinforced concrete beam shown in FIG. 8 to obtain the crack width distribution corresponding to the reinforcing steel corrosion rate conforming to the logarithmic distribution. Finally, by repeatedly sampling to generate a distribution of reinforcing steel corrosion rate under different degrees of corrosion, and by mapping the concrete surface crack width distribution results generated under each distribution of the reinforcing steel corrosion rate one-to-one, data augmentation can be achieved to obtain a mapping relationship between the spatial distribution of reinforcing steel corrosion rate and the crack width distribution, as shown in FIG. 12. C is the cover thickness, and d is the reinforcing steel diameter. The sequence-to-sequence mapping database obtained in this embodiment can be used as a training dataset for a neural network model (sequence-to-sequence data pattern). This allows for the prediction of the spatial distribution of reinforcing steel corrosion rate inside the concrete structure based on the surface crack width distribution detected, enabling probabilistic prediction of the long-term performance of the concrete structure.

It should be noted that the above embodiments are for illustrative purposes only and do not constitute a limitation on the data augmentation methods described in the present application. Any simple modifications and variations made on the basis of this technical concept shall fall within the scope of protection of the present application.

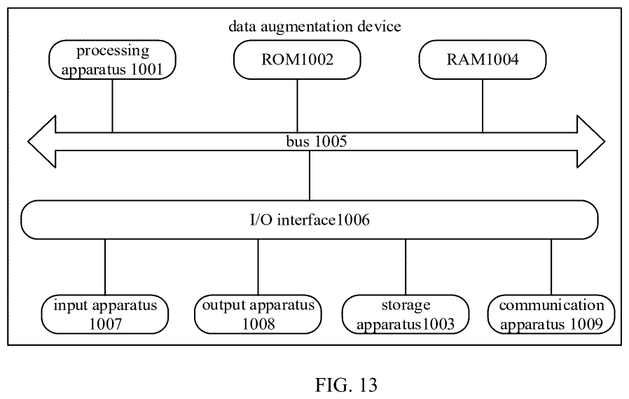

The present application provides a data augmentation device. Referring to FIG. 13, the data augmentation device includes: at least one processor; and a memory communicatively connected to the at least one processor; where the memory stores instructions executable by the at least one processor, and the instructions are executed by the at least one processor so that the at least one processor can perform the data augmentation method in the above embodiment.

As shown in FIG. 13, it shows a schematic diagram of a device structure of a hardware operating environment involved in the data augmentation method according to an embodiment of the present application. The data augmentation device in this embodiment may include, but is not limited to, mobile terminals such as mobile phones, laptops, digital broadcast receivers, Personal Digital Assistants (PDAs), Portable Application Descriptions (PADs), Portable Media Players (PMPs), in-vehicle terminals (e.g., in-vehicle navigation terminals), etc., and fixed terminals such as digital TVs and desktop computers.

It should be noted that the data augmentation device shown in FIG. 13 is merely an embodiment and should not be construed as limiting the functionality and scope of use of the embodiments of the present application.

As shown in FIG. 13, the data augmentation device may include a processing apparatus 1001 (e.g., a central processing unit, a graphics processing unit, etc.), which may perform various appropriate actions and processing according to a program stored in read-only memory (ROM) 1002 or a program loaded from storage apparatus 1003 into random access memory (RAM) 1004. Various programs and data required for the operation of the data augmentation device are also stored in RAM 1004. The processing apparatus 1001, ROM 1002, and RAM 1004 are connected to each other via a bus 1005. An input/output (I/O) interface 1006 is also connected to the bus 1005. Generally, the following systems may be connected to the I/O interface 1006: an input apparatus 1007 including, for example, a touch screen, a touchpad, a keyboard, a mouse, an image sensor, a microphone, an accelerometer, a gyroscope, etc.; an output apparatus 1008 including, for example, a liquid crystal display (LCD), a speaker, a vibrator, etc.; a storage apparatus 1003 including, for example, a magnetic tape, a hard disk, etc.; and a communication apparatus 1009. The communication apparatus 1009 allows the data augmentation device to communicate with other devices wirelessly or by wire to exchange data. Although the data augmentation device with various systems is shown in the figure, it should be understood that it is not required to implement or have all the systems shown. More or fewer systems may be implemented or have alternatively.

According to the embodiments of the present application, the process described above with reference to the flowchart can be implemented as a computer software program. For example, the embodiments disclosed in the present application include a computer program product, which includes a data augmentation computer program carried on a computer-readable medium, and the data augmentation computer program includes a program code for executing the method shown in the flowchart. In such an embodiment, the data augmentation computer program can be downloaded and installed from a network through a communication apparatus, or installed from a storage apparatus 1003, or installed from a ROM 1002. When the computer program is executed by the processing apparatus 1001, the above functions defined in the method of the embodiment disclosed in the present application are executed.

The data augmentation device provided in the present application, using the data augmentation method in the above embodiments, can solve the problem of very limited data available for obtaining this type of sequence-to-sequence mapping relationship under existing laboratory conditions. Compared with the related art, the beneficial effects of the data augmentation device provided in the present application are the same as the beneficial effects of the data augmentation method provided in the above embodiments, and other technical features in the data augmentation device are the same as the features disclosed in the previous embodiment method, and will not be described in detail here.

It should be understood that the various parts disclosed in the present application can be implemented in hardware, software, firmware, or a combination thereof. In the description of the above embodiments, specific features, structures, materials, or characteristics can be combined in any one or more embodiments or examples in a suitable manner.

The above description is only for specific embodiments of the present application, but the scope of protection of the present application is not limited thereto. Those skilled in the art can easily think of changes or substitutions within the technical scope disclosed in the present application, which should be included in the protection scope of the present application. Therefore, the protection scope of the present application should be based on the protection scope of the claims.

The present application provides a computer-readable storage medium having computer-readable program instructions stored thereon (i.e., a data augmentation program), and the computer-readable program instructions are used to execute the data augmentation method described in the above embodiments.

The computer-readable storage medium provided in the present application can be, for example, a USB flash drive, but is not limited to electrical, magnetic, optical, electromagnetic, infrared, or semiconductor systems, devices, or any combination of the above. More specific examples of computer-readable storage media may include, but are not limited to: an electrical connection with one or more wires, a portable computer disk, a hard disk, a RAM, a ROM, an erasable programmable read-only memory (EPROM), an optical fiber, a portable compact disk read-only memory (CD-ROM), an optical storage device, a magnetic storage device, or any suitable combination of the above. In this embodiment, the computer-readable storage medium may be any tangible medium containing or storing a program, which may be used by or in combination with an instruction execution system, system or device. The program code contained on the computer-readable storage medium may be transmitted using any appropriate medium, including but not limited to: wires, optical cables, Radio Frequency (RF), etc., or any suitable combination of the above.

The above computer-readable storage medium may be included in the data augmentation device; or it may exist separately without being assembled into the data augmentation device.

The above computer-readable storage medium carries one or more programs, which, when executed by the data augmentation device, enable the data augmentation device to perform data augmentation based on the mapping relationship between the reinforcing steel corrosion rate distribution and the crack width distribution using the random finite element method.

The present application may be written in one or more programming languages or a combination thereof, including object-oriented programming languages, such as Java, Smalltalk, C++, and conventional procedural programming languages, such as “C” or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a local area network (LAN) or a wide area network (WAN), or may be connected to an external computer (e.g., via the Internet using an Internet service provider).

The flowchart and block diagram in the accompanying drawings illustrate the possible architecture, function and operation of the system, method and computer program product according to various embodiments of the present application. In this regard, each square box in the flow chart or block diagram can represent a module, a program segment or a part of a code, and the module, the program segment or a part of the code contains one or more executable instructions for realizing the specified logical function. It should also be noted that in some alternative implementations, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The modules involved in the embodiments described in the present application can be implemented in software or hardware. Where the name of the module does not constitute a limitation on the unit itself in some cases.

The readable storage medium provided by the present application is a computer-readable storage medium that stores computer-readable program instructions (i.e., data augmentation programs) for performing the above data augmentation method, which can solve the problem of very limited data available for obtaining this type of sequence-to-sequence mapping relationship under existing laboratory conditions. Compared to the related art, the beneficial effects of the computer-readable storage medium provided in the present application are the same as beneficial effects of the data augmentation method provided in the above embodiments, and therefore will not be described in detail here.

The present application also provides a computer program product, including a data augmentation program, when executed, the data augmentation method described above is implemented.

The computer program product provided in the present application can solve the problem of limited data available for obtaining this type of sequence-to-sequence mapping relationship under existing laboratory conditions. Compared with the related art, the beneficial effects of the computer program product provided in the present application are the same as the beneficial effects of the data augmentation method provided in the above embodiments, and will not be described in detail here.

The above descriptions are only embodiments of the present application, and are not intended to limit the scope of the present application. Under the concept of the present application, equivalent structural transformations made according to the description and drawings of the present application, or direct/indirect application in other related technical fields are included in the scope of the present application.

What is claimed is:

1. A data augmentation method, comprising:
obtaining spatial distribution of reinforcing steel corrosion rate along a length direction, determining a standard deviation of the reinforcing steel corrosion rate based on the spatial distribution of reinforcing steel corrosion rate along the length direction, and determining a logarithmic functional relationship between the standard deviation of reinforcing steel corrosion rate and an average reinforcing steel corrosion rate through a fitting method;
simulating the spatial distribution of reinforcing steel corrosion rate along the length direction using a Nataf transformation method based on the standard deviation of the reinforcing steel corrosion rate and the average reinforcing steel corrosion rate to generate a distribution of reinforcing steel corrosion rate conforming to a logarithmic distribution, inputting the distribution of reinforcing steel corrosion rate into a finite element model of the reinforced concrete beam, and obtaining a crack width distribution corresponding to the distribution of reinforcing steel corrosion rate conforming to the logarithmic distribution; and
repeatedly performing the steps of: obtaining the spatial distribution of reinforcing steel corrosion rate along the length direction, determining the standard deviation of the reinforcing steel corrosion rate based on the spatial distribution of the reinforcing steel corrosion rate along the length direction, and determining the logarithmic functional relationship between the standard deviation of the reinforcing steel corrosion rate and the average reinforcing steel corrosion rate through the fitting method; and simulating the spatial distribution of reinforcing steel corrosion rate along the length direction using the Nataf transformation method based on the standard deviation of the reinforcing steel corrosion rate and the average reinforcing steel corrosion rate to generate the distribution of reinforcing steel corrosion rate conforming to the logarithmic distribution, inputting the distribution of reinforcing steel corrosion rate into the finite element model of the reinforced concrete beam, and obtaining the crack width distribution corresponding to the distribution of reinforcing steel corrosion rate conforming to the logarithmic distribution, until a termination condition is met, ending the calculation and establishing a mapping relationship between the spatial distribution of the reinforcing steel corrosion rate and the crack width distribution.

2. The data augmentation method according to claim 1, wherein the logarithmic functional relationship between the standard deviation of the reinforcing steel corrosion rate and the average reinforcing steel corrosion rate is:
$$v = 0.08 {η}_{a}^{0.5}$$
wherein υ is a standard deviation of the reinforcing steel corrosion rate, and ηₐ is an average reinforcing steel corrosion rate.

3. The data augmentation method according to claim 1, wherein simulating the spatial distribution of reinforcing steel corrosion rate along the length direction using the Nataf transformation method based on the standard deviation of the reinforcing steel corrosion rate and the average reinforcing steel corrosion rate to generate the distribution of reinforcing steel corrosion rate conforming to the logarithmic distribution, inputting the distribution of reinforcing steel corrosion rate into the finite element model of the reinforced concrete beam, and obtaining the crack width distribution corresponding to the distribution of reinforcing steel corrosion rate conforming to the logarithmic distribution comprises:
simulating the spatial distribution of reinforcing steel corrosion rate along the length direction using the Nataf transformation method based on the standard deviation of the reinforcing steel corrosion rate and the average reinforcing steel corrosion rate, and generating the distribution of reinforcing steel corrosion rate conforming to a logarithmic distribution;
inputting the distribution of reinforcing steel corrosion rate conforming to the logarithmic distribution into a reinforcing steel corrosion expansion model, and calculating an element node expansion displacement applied to a reinforced concrete interface; and
inputting the element node expansion displacement applied to the reinforced concrete interface into the finite element model of the reinforced concrete beam to simulate non-uniform corrosion around the reinforcing steel and along a reinforcing steel axis, and obtaining the crack width distribution corresponding to the distribution of reinforcing steel corrosion rate conforming to the logarithmic distribution.

4. The data augmentation method according to claim 3, wherein non-uniform corrosion around the reinforcing steel generates non-uniform radial expansion pressure on surrounding concrete, and using a corrosion distribution curve to express corrosion expansion behavior of each reinforcing steel cross-section, and the expression for the corrosion distribution curve is:
$${u}_{θ} = \{ \begin{matrix}{u}_{2} & 0 ° \leq θ \leq 180 ° \\ \frac{( R + {u}_{1} ) \cdot ( R + {u}_{2} )}{\sqrt{{( R + {u}_{1} )}^{2} {cos}^{2} θ + {( R + {u}_{2} )}^{2} {sin}^{2} θ}} - R & 180 ° \leq θ \leq 360 °\end{matrix}$$
wherein u_{θ} is a function value corresponding to the corrosion distribution curve, R is an original radius of the reinforcing steel, u₁ is a maximum corrosion layer thickness closest to a concrete surface, and u₂ is a corrosion layer thickness on a side away from the concrete surface.

5. The data augmentation method according to claim 3, wherein a relationship for the element node expansion displacement applied to the reinforced concrete interface is as follows:
$${u}_{1} = 10 ( 2 R {φ}^{- 1} η - 4 δ ) / 11$$
wherein u₁ is an element node expansion displacement applied to the reinforced concrete interface, and is a maximum corrosion layer thickness closest to the concrete surface; η is an experimentally measured corrosion rate, φ is a calibration coefficient, R is an original radius of the reinforcing steel, and δ is a thickness of the porous zone formed at the reinforcing steel or concrete interface.

6. The data augmentation method according to claim 3, wherein the establishing the finite element model of the reinforced concrete beam comprises:
inputting a fracture softening curve into a concrete model to simulate tensile behavior of the concrete; and
establishing the finite element model of the reinforced concrete beam based on the tensile behavior of the concrete.

7. The data augmentation method according to claim 1, wherein the obtaining the spatial distribution of the reinforcing steel corrosion rate along the length direction comprises:
obtaining design parameters of the reinforced concrete beam member, wherein the design parameters comprise a length, a cross-sectional dimension, a concrete strength, a concrete cover thickness, and a reinforcing steel diameter of the reinforced concrete beam member; and
based on the design parameters of the reinforced concrete beam, conducting an accelerated corrosion experiment on the reinforced concrete beam member by applying an electric current, and obtaining the spatial distribution of the reinforcing steel corrosion rate along the length direction.

8. A data augmentation device, comprising a memory, a processor, and a data augmentation program stored on the memory and executable on the processor, wherein the data augmentation program is configured to implement the data augmentation method according to claim 1.

9. A non-transitory computer-readable storage medium, wherein the non-transitory computer-readable storage medium stores a data augmentation computer program, and the data augmentation computer program is configured to implement the data augmentation method according to claim 1 when executed by a processor.

10. A computer program product, comprising: a data augmentation program, wherein the data augmentation computer program is configured to implement the data augmentation method according to claim 1 when executed by a processor.
